(19) United States
(12) Patent Application Publication
(10) Pub. No.: US 2009/0081994 A1
(43) Pub. Date: Mar. 26, 2009

(54) Method and System for Improving Wireless Customer Experience by Anticipating and Explaining Communication Quality Problems Through Notifications

(75) Inventors: Adam Drobot, Bernardsville, NJ (US); Benjamin W. Falchuk, Upper Nyack, NY (US); Shoshana K. Loeb, Philadelphia, PA (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/177,961

(22) Filed: Jul. 23, 2008

Related U.S. Application Data
(60) Provisional application No. 60/961,625, filed on Jul. 23, 2007.

(51) Int. Cl. H04M 1/00

(52) U.S. Cl. 455/412.2

(57) ABSTRACT

In wireless mobile device system a distributed set of software and/or hardware components provide continual warnings, monitoring, and explanations of device and system communication issues to mobile devices/users. The warnings and explanations are relevant to past, current, and future communications events that cause end-to-end quality problems such as disruptions including “dropped call”.

### CROSS-REFERENCE TO RELATED APPLICATIONS

This application claims the benefit of the filing date of U.S. Provisional Patent Application No. 60/961,625, filed Jul. 23, 2007, the disclosure of which is hereby incorporated herein by reference.

### FIELD OF THE INVENTION

The present invention concerns wireless mobile devices. Specifically, the invention concerns a distributed set of software and/or hardware components in a mobile system that together provide continual warnings, monitoring, and explanations to mobile users. The warnings and explanations are relevant to past, current, and future communications events that cause end-to-end quality problems, e.g., disruptions such as “dropped call”.

### BACKGROUND OF THE INVENTION

Mobile devices capable of establishing and maintaining communications sessions are now ubiquitous. Customers demand connectivity at all times and penalize a service provider if they feel service is not at a satisfactory level. In reality though, customer communication sessions can be disrupted abruptly, or in some cases not even be established for a variety of reasons including: weak signal strength as sensed by the mobile device due to factors such as geography, climate, motion, etc.; network congestion which prevents the device from obtaining the appropriate resources needed for establishing and continuing a session; service providers (e.g., mobile web) servers overload that can be detected; or device related errors such as misconfigurations, low battery power, etc.

Large numbers of session disruptions and interruptions, or problems with application performance that does not meet customer expectations can result in a suboptimal customer experience resulting in customer-churn and loss of revenues to the service provider. There will always be cases in which undesirable session-marring communication events cannot be avoided. However, in many scenarios it is possible to anticipate these events and warn the customer, or explain past disruptions or events to the customer. This situation applies to sessions of the following type: single person sessions between a user and a Web site or data stream or LBS navigation services; 2-person session involving circuit switched, VoIP or video calls; 3 or more person session involving circuit switched, VoIP, or video conference call; or multi-person session with access to information services such as community shopping activity where several people shop at a website simultaneously while on a voice or video call.

Currently, customers are rarely, if ever, warned before a quality marring communications event occurs. When such events do disrupt sessions, an explanation is rarely provided by the communication service provider to the user and a corrective action such as reconnecting a dropped call is not provided. In fact, no such “early warning system” for disruptions currently exists.

There are rationales and advantages of providing an early warning system and possible remediation system. For example, more than ever, customers are willing and able to perform “self-service” to correct their problems, rather than wait for technicians or help-desk assistance which is costly for the service provider. Also, a solution that provides customers disruption warnings as well as post-disruption insights allows the customer to self-solve problems thereby enhancing the perceived customer experience. Enhanced customer experience translates to less “customer chum” for the service provider.

### BRIEF SUMMARY OF THE INVENTION

The invention comprises a distributed set of software and/or hardware components that together provide continual warnings, monitoring, and explanations of problems to mobile users. The warnings and explanations are relevant to past, current, and future communications events that cause end-to-end quality problems, e.g., disruptions such as “dropped call”. In accordance with the invention architecture of the present invention, the distributed components can be resident on a mobile device platform. Mobile device Operating Systems (OS) can support software components or hardware components. Mobile devices that communicate include cell-phones, PDAs, laptops, automobiles, and the like. The invention components residing on these platforms are largely invisible to the end-user although they will convey information to the user intermittently. The components can also reside on backend servers. Service providers communication and support infrastructure hosts many applications servers for various uses such as billing, authentication, and so forth. The invention components may be resident on these servers and if the provider's systems are accessible via APIs there is a fairly complete picture of network operations. The invention components are far more global than the components that reside only on the mobile device platform.

Given the connectivity between backend systems in the infrastructure, the invention components will have access to data and information in IMS or 3G components such as HSS, MSCs, SIP servers (CSCF), and the like. The information stored on these servers provides a basis for inference, explanations, and anticipation.

For customers with mobile devices employing the teachings of the present invention, the perceived customer experience is improved with the inclusion of early warnings of disruptions and explanations to help provide users with both an opportunity to adapt to disruptions before they happen (e.g., in a 2-party voice call by, for example, agreeing to recommence the call in several minutes), and to provide a possible explanation of how to mitigate the event so that it does not happen (e.g., “plug your phone into the AC power source so the battery does completely lose its charge during this call!”).

These and other advantages of the present invention will become more clearly apparent when the following description is read in conjunction with the accompanying drawings.

### BRIEF DESCRIPTION OF THE DRAWINGS

FIG. 1 shows schematically the system architecture of the present invention.

FIG. 2 shows diagrammatically the actions of the notification agent, knowledge base, and sensor agent.

FIG. 3 shows a use-case related to the battery power.

FIG. 4 shows a use-case where there is a risk of a quality disruption or dropped call.

FIG. 5 illustrates a use-case related to misconfiguration warnings.

FIG. 6 shows a use-case explaining a recent communication event.

FIG. 7 illustrates a process for sensor agent training.

### DETAILED DESCRIPTION

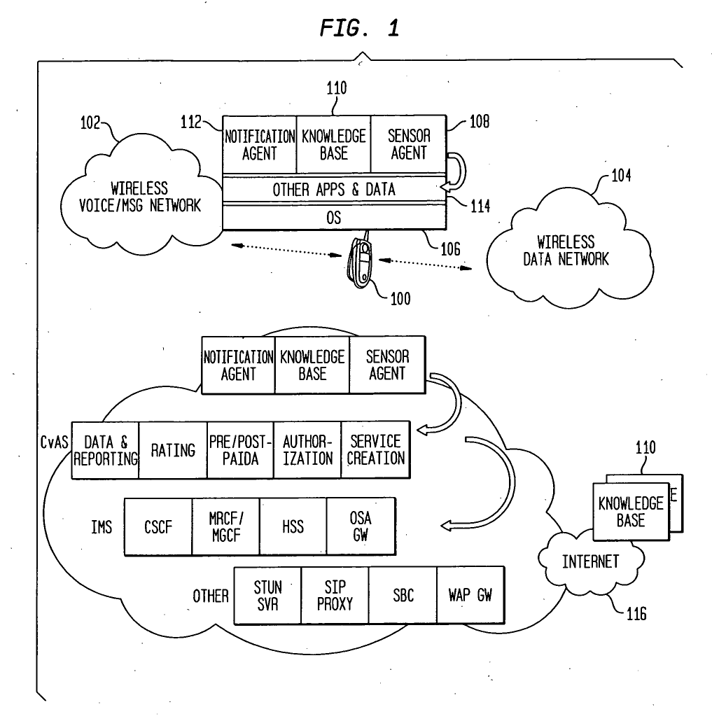

Referring now to the figures and to FIG. 1 in particular, there is shown schematically the system architecture of the present invention. A wireless mobile device 100 is in communication with a wireless voice/messaging network 102 and/or a wireless data network 104. The mobile device includes an operating system OS 106 which includes a sensor agent 108 for sensing predetermined network and mobile device parameters, knowledge base 110 which contains data for determining the condition of the network and mobile device based on the sensed values, and a notification agent 112 for providing warnings and or explanations to the mobile device. The OS also may include other applications and data 114.

The knowledge database 110 can comprise a local memory or may be connected to the internet 116 where the information may be resident. Depending upon the network used, the notification agent, knowledge base and sensor agent may be coupled to suitable information databases maintained by the service provider. The information monitored is dependent on the service provided. This may include, but not be limited to, CvAS, IMS or any other protocol used in connection with the provision of communication services, as shown in FIG. 1.

The knowledge base architecture is such that the knowledge base is provisioned with rules or facts where agent implementation can be procedural or declarative. The underlying ontology of artifacts is preferably XML (and knowledge languages such as RDF, OWL, etc.). Other languages are also possible.

Each unit of instrumented device/application data (e.g. SIP settings, session information) is described canonically. That is, first establish the instrumented device/application data that is to be accessed by the agent (e.g. SIP settings in a file, system clocks, session information) and describe the information in terms of the knowledge base including: application type, application name, instrumented data. Second, for each instrumented data encode a computational way to access the data with respect to artifacts that it already understands (e.g. a set of low level system calls). Instrumenting data is similar to creating a “service bus” layer on the device. If a centralized “server” is involved, it must be described in the knowledge base (including all its endpoint (e.g. SMS, IP, etc.)). Define the rules or goals which will govern the sensor agent's behavior with respect to the instrumented data. It is possible to use if-then style rules (e.g. “poll SIP settings after dialer starts up; if ser could use goal-based directives (a la multi-agent systems). Rules encode simple notions of time which is useful for monitoring situations, for example “access the SIP settings every n minutes” and temporal operators such as “before” and “after”.

The sensor agent has to be “trained” or provisioned on a per-Operating System basis (perhaps on per-phone basis). This is because access to data and system information will vary between devices and the OS. As described below, “training” involves populating the knowledge base and linking the sensor agent with the information. A fully trained agent is activated and runs as a background thread until terminated

The Notification Agent is a thread that runs on the device in the background (transparent to the user). The notification agent relies on the “training” information in the knowledge base to allow it to make changes to application data and windows, e.g. render a color warning code over top of a contact list as described below. The notification agent is able to invoke low-level communication features of the device when asked to transmit information by sending data (via SMS, or any other transmission type) and receiving and interpreting data (vis SMS or other). A special encoding or header identifies incoming and outgoing data as special directives to be used in the use cases described below, e.g. the sending of SIP settings to another peer.

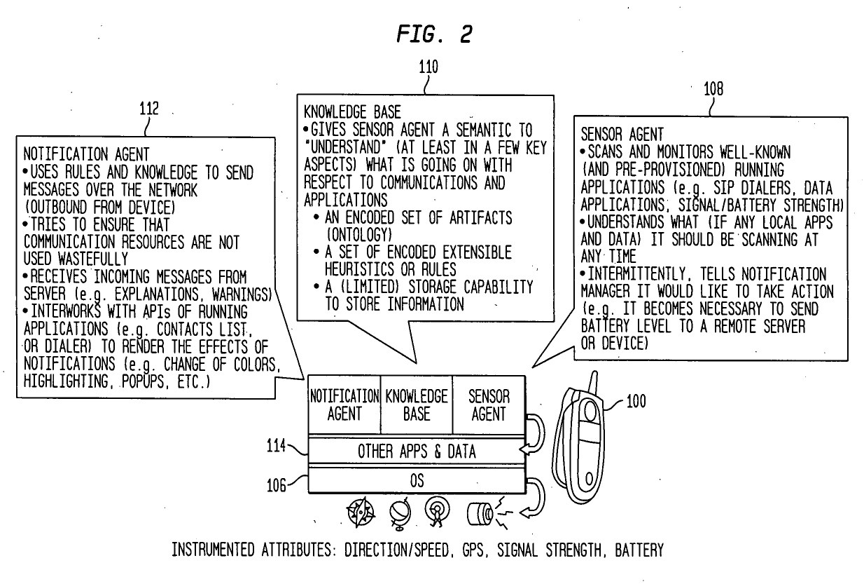

FIG. 2 shows diagrammatically the actions of the notification agent, knowledge base, and sensor agent. The notification agent uses rules and knowledge to send messages over the network (outbound from the mobile device), tries to ensure that communication resources are not used wastefully, receives incoming messages from a server (e.g., explanations or warnings), and interworks with APIs of running applications (e.g. contact lists or dialer) to render the effects of notifications such as change of colors, highlighting, pop-ups, sounds, etc.

The knowledge base provides the sensor agent a semantic to understand what is happening with regard to communications and applications: an encoded set of artifacts (ontology), a set of encoded extensible heuristics or rules and a limited storage capability to store information.

The sensor agent scans and monitors well-known and pre-provisioned running applications such as SIP dialers, data applications, signal/battery strengths, understands what if any local apps and data should be scanning at any time, and intermittently informs the notification manager it would like to take an action such as it becomes necessary to send battery level to a remote server or device.

The mobile device might include instrumented attributes such as direction/speed of motion of the device, GPS location, and signal strength and battery power level.

The following are examples of possible use-cases of the invention. In the description it is assumed that the mobile devices have “opted-in” to a service that, in part, implements the present invention. That is, a service provider runs and manages the invention components either solely on the mobile devices, solely in the infrastructure, or a combination of these two options. The mobile devices are referred to as A, B, C, etc.

The agents or components can be in either software or hardware and can be hard-wired or very adaptive intelligent agents.

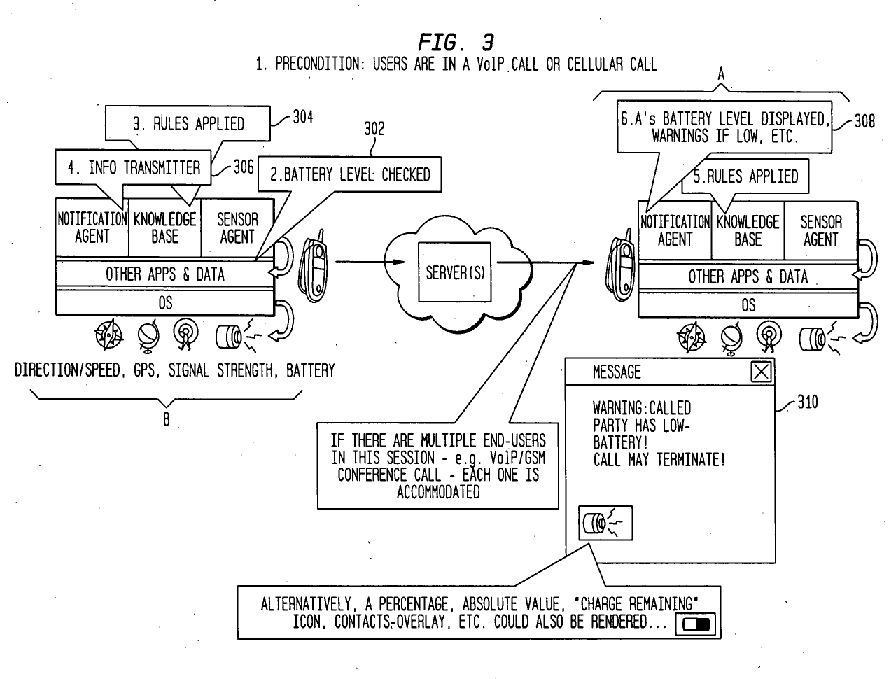

FIG. 3 shows a use-case related to the battery power. Initially it is assumed that the users are on a VoIP call or cellular call. While A and B are having a voice session between them, B's battery level is checked 302 and by applying rules 304, it is determined that B's battery is below a “dangerous” threshold. The invention components anticipate that the current session will be interrupted by a loss of battery power very soon and accordingly the information is transmitted 306 and the components ensure that at this moment A's view (and B's view) of B's battery level is updated (such as on an icon on A's screen, or via some other notification 310) 308, thereby giving A full awareness of the low battery power condition of B. As a result of implementing the invention, A and B avoid a “surprise” session disruption, and even if the disruption cannot be avoided, e.g. B does not have access to an AC adapter at the moment, A and B can verbally make a “backup plan” before B's battery loses its power. If there is more than one device connected to B's device, each connected device will receive the low battery power information.

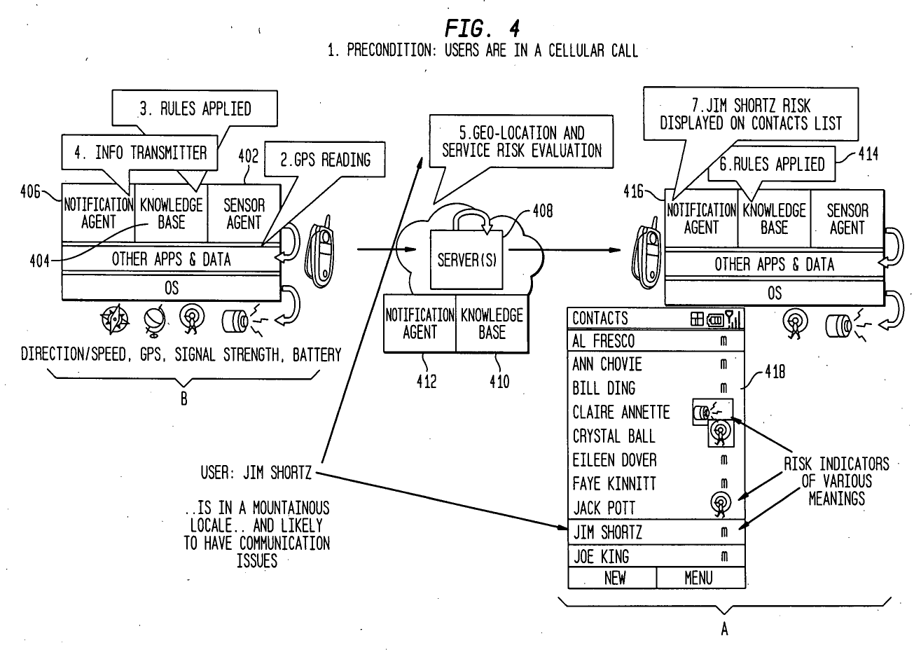

FIG. 4 shows a use-case where there is a risk of a quality disruption or dropped call. Initially it is assumed that the users are on a VoIP call or a cellular call. User A has a contacts list on the mobile device. However, each contact has a current and dynamically changing “risk” factor associated with it with respect to the probability that there will be quality disruptions if there is a session with this contact. In accordance with the invention, the described components manage the risk analysis and computation and give user A awareness of this risk on a per-contact basis. The components do this by continually computing risk for B's contacts (from A's perspective) and giving some visual cue to user A. For example, B determines its location from a GPS device (sensor agent 402) and applies rules and transmits the location information from the knowledge base 404 via notification agent 406 to a server 408 which has a knowledge base 410 and a notification agent 412. The server uses the geo-location and makes a service risk evaluation and transmits the evaluation to A. A applies its rules 414 and notification agent 416 displays the information on the contact list 418. Cues may include: color overlay onto the contacts name in the list (e.g. red overlay implies risky contact to call), last-known battery level overlay, current WLAN signal strength overlay, elevation, location (e.g. urban, suburban, mountainous). The result is that before A even creates a session (e.g. voice call) to a contact on his/her contact list, A gets a sense of how risky such a session may be based on a variety of parameters and variables. A may decide to use some other communications channel if the risk of a successful communication via a voice channel is too risky.

Another use-case involves travel in or near a region of poor signal strength. Users A and B have a session (voice). The invention components note that A is traveling and nearing a geographic region of poor signal strength. The determination may be made in different ways such as basing the decision on signal maps, geography, or the like. In an example, the region has high WiFi (or WiMAX) hotspot density. Anticipating imminent handover the invention “warns” both users that “disruption is possible imminently but the session will likely roam to WiFi network”. Alternatively, if the region has no WiFi (or WiMAX) hotspots then the users are warned of likely imminent session disruption. The result is that users gain awareness of imminent disruptions and can make provisional plans to communicate via other means.

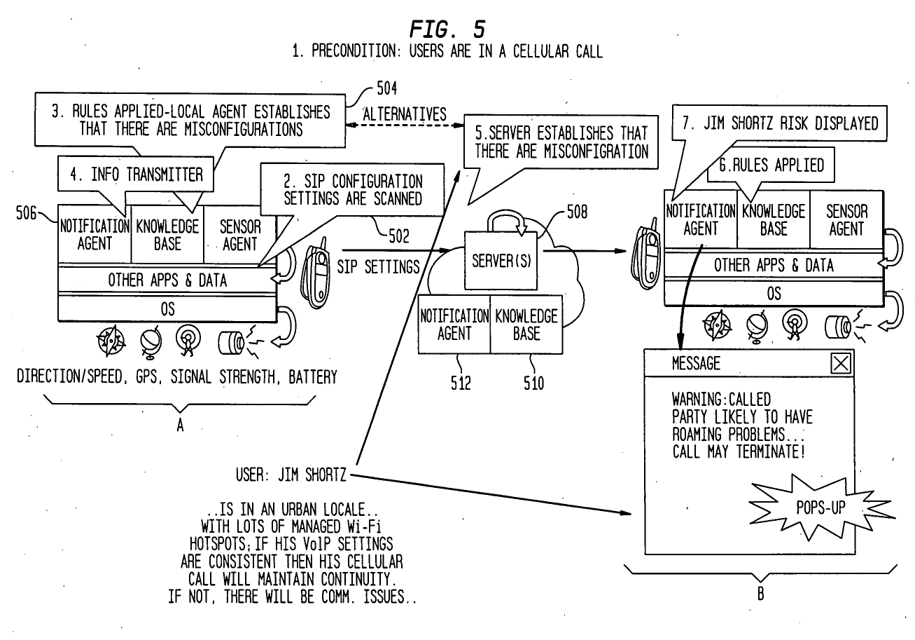

FIG. 5 illustrates a use-case related to misconfiguration warnings. Initially the users are on a cellular call. User A has a dual mode phone (WiFi and cellular) that will connect between VoIP and cellular voice calls. SIP configuration settings are scanned 502 and rules in knowledge base establish that there is a misconfiguration 504. The information is transmitted from notification agent 506 to server 508 which has a Knowledge Base 510 and a Notification Agent 512. The server 508 establishes that there are misconfigurations. A receives the notification from the server and detects that there is a misconfiguration of the SIP account settings on the device upon which the dual-mode dialer depends. The settings could be the SIP account, SIP IP address, password, etc. The invention creates a notification/warning for user A to act upon before the misconfiguration causes a problem.

In another example, the invention components on A's phone determine that the phone cannot enter hands-free mode, for example by detecting a problem with a low-level driver. The components detect also that A's device is entering the State of New York which requires hands-free and a message is sent to A warning user A of these facts and optionally disabling the phone temporarily for safety purposes. The result is that the user is made aware of misconfigurations on the phone (software/hardware) that may cause session quality issues.

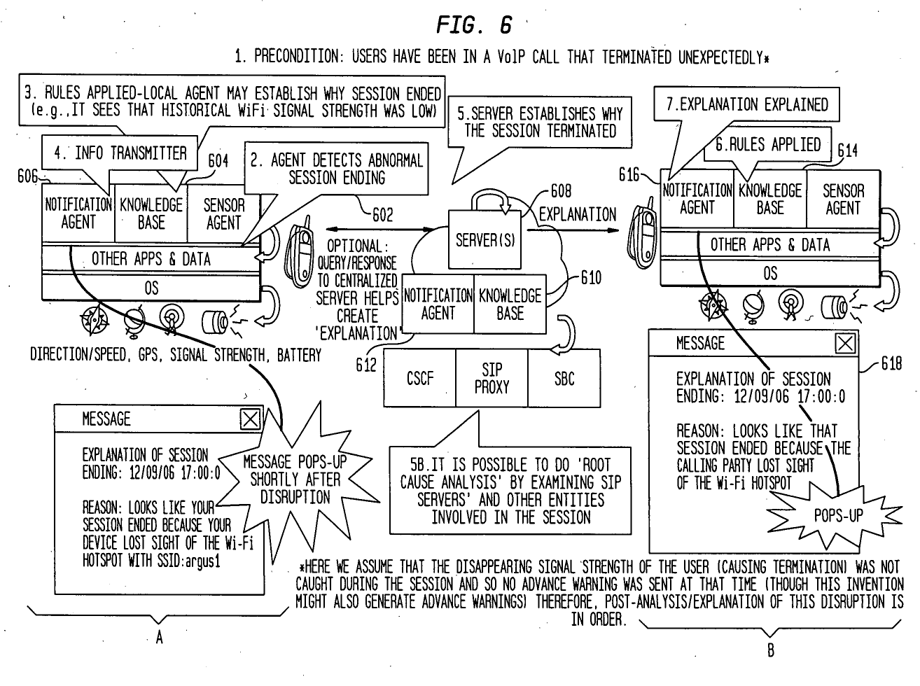

FIG. 6 shows a use-case explaining a recent communication event. Initially, it is assumed that the users have been on a VoIP call that terminated unexpectedly. Users A and B have already experienced a disruption to their session and their call has been dropped. Device A detects an abnormal session ending 602. The knowledge base 604 applies rules and provides a reason for the session ending. Notification Agent 606 sends the reason to server 608 which has a Knowledge Base 610 and a Notification Agent 612. The server establishes why the session terminated. Also, it is possible that the knowledge base 610 in server 608 may be able to perform root cause analysis (RCA) by examining SIP servers and other entities involved in the session. The explanation for the session drop is provided from notification agent 612 to B. B applies rules from knowledge base 614 and notification agent 616 displays the explanation 618. Upon resumption or shortly thereafter the invention components on the device and possibly on a server infer the reason for the drop for example that device A had very low WiFi signal strength just before the drop, and makes the users aware of the reason via a notification. The result is that users are promptly given “explanations” of past disruptions and quality issues.

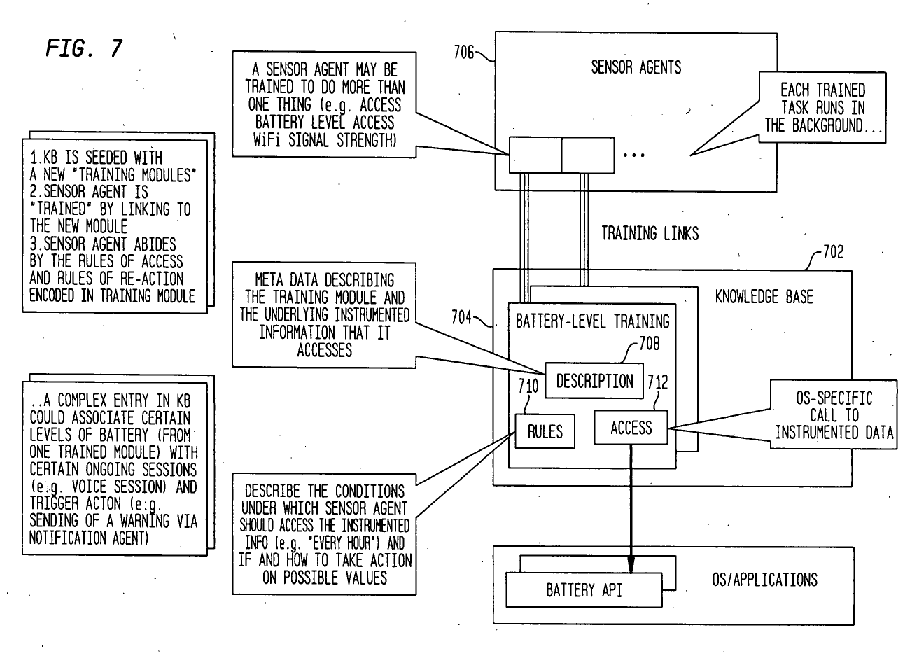

FIG. 7 illustrates a process for sensor agent training. The knowledge base 702 is seeded with new training modules 704. The training modules include description module 708, rules module 710 and access module 712. The description module has meta data describing the training module and the underlying instrumented information that it accesses. The rules module describe the conditions under which the sensor agent should access the instrumented information, for example, every hour, and if and how to take action on possible values. The access module is an OS-specific call to instrumented data, for example to a battery API in OS/Applications. Sensor Agent 706 is trained by linking the sensor agent to the new module in the knowledge base. The sensor agent abides by the rules of access and rules of re-action encoded in the training module. Each trained task runs in the background. The sensor agent can be trained to do more than one task such as battery strength level, and access WiFi signal strength. A complex entry in the knowledge base could associate certain levels of battery (from one trained module) with certain ongoing sessions, e.g. voice session, and trigger action such as sending a warning via the notification agent.

While there has been described and illustrated a method and system for improving wireless customer experience, it will be apparent to those skilled in the art that modifications and variations are possible without deviating from the broad teachings of the present invention which shall be limited solely by the scope of the claims appended hereto.

What is claimed is:

1. A system for anticipating a quality problem in a wireless mobile communication system comprising:
an operating system for controlling a mobile device;
a sensor agent for detecting predetermined parameters of a communication involving the mobile device;
a knowledge base with rules for applying the rules to the detected parameters to anticipate any quality problem involving the mobile device; and
a notification agent for transmitting information regarding anticipated quality problems involving the mobile device.

2. A method of anticipating a quality problem in a wireless mobile communication system comprising the steps of:
detecting predetermined parameters of a communication involving a mobile device;
applying rules in a knowledge base to the detected parameters to anticipate any quality problem involving the mobile device; and
transmitting information regarding anticipated quality problems involving the mobile device.
